(19) United States
(12) Patent Application Publication
(10) Pub. No.: US 2005/0197747 A1
(43) Pub. Date: Sep. 8, 2005

(54) In-vehicle computer system

(76) Inventors: Jason Rappaport, Staten Island, NY (US); Emanuel Melman, Brooklyn, NY (US)

Correspondence Address: JENNIFER MEREDITH;MEREDITH & KEYHANI, PLLC, 330 MADISON AVE., 6TH FLOOR, NEW YORK, NY, 10017, US

(21) Appl. No.: 11/056,859

(22) Filed: Feb. 12, 2005

Related U.S. Application Data
(60) Provisional application No. 60/550,102, filed on Mar. 4, 2004.

(51) Int. Cl. G05D 1/00

(52) U.S. Cl. 701/1

(57) ABSTRACT

The present invention discloses and in-vehicle computer system that can support can support multiple types of display peripherals, a multitude of various multimedia peripheral devices, navigational systems, vehicle diagnostic systems, and in vehicle networking, while providing a user with all the functionality of a personal computer and organizer in the environment of an automobile.

This application claims priority to provisional patent application No. 60/550,102 entitled “In-vehicle computer system” filed Mar. 4, 2004.

### BACKGROUND OF THE INVENTION

The present invention generally relates to car mounted electronic devices. More particularly, the present invention relates to a computer adapted to the environment of an automobile that performs the functions of a computer for use in conjunction with a multitude of peripheral devices such as a navigational system, factory automobile computer system, or multimedia system.

U.S. Pat. No. 5,794,164 issued to Beckert et al discloses a vehicle computer system. The vehicle computer system mounted in the vehicle dashboard, allows the user to execute an open platform operating system which supports multiple different applications supplied by a vehicle user. Unlike the '164 patent, the present invention does not have a face plate attached to the housing, it may also run both embedded and non embedded operating systems which are capable of running multiple threads. Also unlike the Beckert invention, the present invention not only supports applications such as navigational, entertainment, communications, security and diagnostic applications, but also supports mobile office applications.

U.S. Pat. No. 6,201,540 issued to Gallup et al. discloses graphical interface components for in-dash automotive accessories. The '540 patent discloses an in-dash computer system having a computer running on an open platform operating system which supports multiple applications. Unlike the '540 patent, which also has an operator interface that is mountable for viewing by an operator of an automobile to display the application icons with a fixed focus position, the present invention can support multiple user interfaces, including OEM automobile screens, LCD screens and multiple other display peripherals throughout the automobile.

U.S. Pat. No. 6,202,008 issued to Beckert et al. discloses a vehicle computer system with wireless Internet connectivity. The vehicle computer system has a support module in communication with a computer module, faceplate module, and a USB hub. Unlike the '008 patent, the present invention incorporates a peripheral device interface in communication with peripheral multimedia devices, input devices, diagnostic systems, navigational systems, communication systems, and in vehicle networking system.

U.S. Pat. No. 6,526,335 issued to Treyz et al. discloses an automobile personal computer system in wireless communication with an in-home electronic device. The Treyz invention also describes a method of controlling the operation of an automobile from the interior of a home using an in-home electronic device with a flat panel display. Unlike the '335 patent, the present invention can synchronize data on the in-vehicle computer with base station computers such as a home based personal computer, office based personal computer as well as off site computer stations and vice versa.

The use of an in-vehicle computer system is well known within the art. Most modern day automobiles implement a computer of some sort whether it be an automobile diagnostic computer or an in vehicle navigational system. Although the prior art performs its specific functions, there is a need within the art for an in-vehicle computer system that can support can support multiple types of display peripherals, a multitude of various multimedia peripheral devices, navigational systems, vehicle diagnostic systems, and in vehicle networking. There is also a need within the art for an in-vehicle computer system that can synchronize with a base station computer via wireless connection.

### SUMMARY OF THE INVENTION

The present invention provides in-vehicle computer system that can support can support multiple types of display peripherals, a multitude of various multimedia peripheral devices, navigational systems, vehicle diagnostic systems, and in vehicle networking. There is also a need within the art for an in-vehicle computer system that can synchronize with a base station computer via wireless connection.

According to one embodiment, an in-vehicle computer system is disclosed, the system comprising a computing system housing, at least one display assembly, wherein the at least one display assembly is comprised of a display device, control electronics and a connector, wherein the at least one display is at least 4 inches. The computer system may further comprise a microprocessor system, which is comprised of control circuitry, internal memory and data storage device. The microprocessor system is contained within the computer system housing and in electrical communication with the display assembly, and a power source. Running on the microprocessor system is an operating system capable of running multiple applications simultaneously. A peripheral device interface is in electrical communication with at least one peripheral device via a peripheral device interface connector and the microprocessor system via a device interface connector. The computer system also further comprises a computer input device, and a power supply in electrical communication with the in-vehicle display assembly, the microprocessor system, and the computer input device and the peripheral device interface.

According to one embodiment, an in-vehicle computer system is disclosed, the system comprising a computing system housing, at least one display assembly, wherein the at least one display assembly is comprised of a display device, control electronics and a connector, wherein the at least one display is at least 4 inches. The computer system may further comprise a microprocessor system, which is comprised of control circuitry, internal memory and data storage device. The microprocessor system is contained within the computer system housing and in electrical communication with the display assembly, and a power source. Running on the microprocessor system is an operating system capable of running multiple applications simultaneously. A peripheral device interface is in electrical communication with at least two peripheral devices via a peripheral device interface connector and the microprocessor system via a device interface connector, wherein at least one of the at least two peripheral devices is an OBDII vehicle diagnostic system. The computer system also further comprises a computer input device, and a power supply in electrical communication with the in-vehicle display assembly, the microprocessor system, and the computer input device and the peripheral device interface.

According to one embodiment, an in-vehicle computer system is disclosed, the system comprising a computing system housing, at least one display assembly, wherein the at least one display assembly is comprised of a display device, control electronics and a connector, wherein the at least one display is at least 4 inches. The computer system may further comprise a microprocessor system, which is comprised of control circuitry, internal memory and data storage device. The microprocessor system is contained within the computer system housing and in electrical communication with the display assembly, and a power source. Running on the microprocessor system is an embedded multithreading operating system capable of running multiple applications simultaneously. A peripheral device interface is in electrical communication with at least two peripheral devices via a peripheral device interface connector and the microprocessor system via a device interface connector, wherein at least one of the at least two peripheral devices is an OBDII vehicle diagnostic system. The peripheral device interface is also in communication with in-vehicle networking using an in-vehicle networking communication protocol. The computer system also further comprises a computer input device, and a power supply in electrical communication with the in-vehicle display assembly, the microprocessor system, and the computer input device and the peripheral device interface.

According to yet another embodiment, a method of synchronizing an in-vehicle computer with a base station computer system is disclosed. The method comprising the following steps: Firstly, determining if network reception is suitable to provide communication with an in-vehicle computer system and a base station computer system. Secondly, establishing a bi-directional network connection between the in-vehicle computer system and the base station computer system. Thirdly, comparing designated data files stored on both the base station computer system and the in-vehicle computer system. Forthly, transmitting and storing updated data files from the base station computer system on the in-vehicle computer system. Finally transmitting and storing updated data files from the in-vehicle computer system on the base station computer system.

These and other features, aspects and advantages of the present invention will become better understood with reference to the following drawings, description and claims.

### BRIEF DESCRIPTION OF THE DRAWINGS

FIG. 1 depicts an in-vehicle computer system.

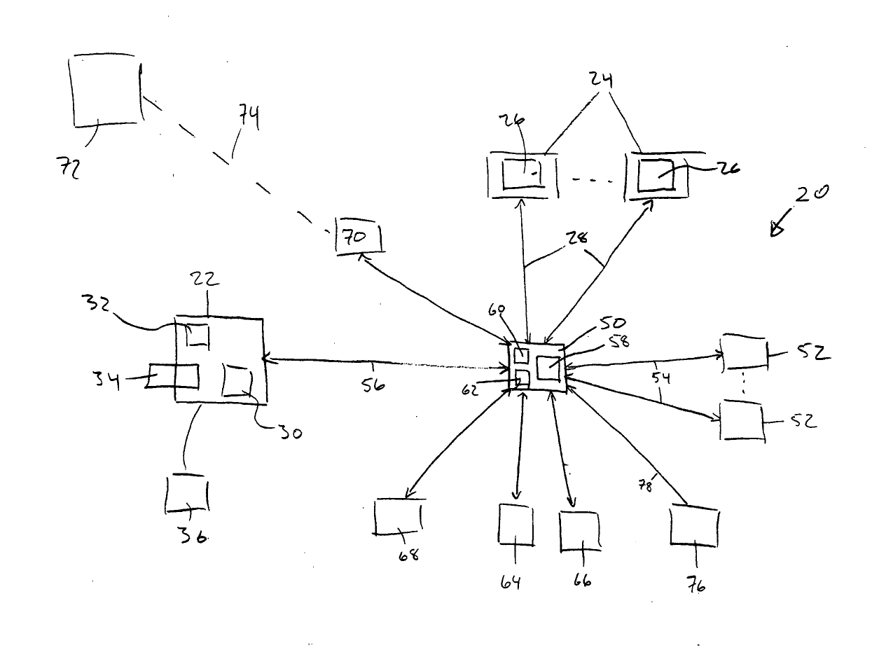

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

According to one embodiment, an in-vehicle computer system 20 is disclosed, the system comprising a computing system housing 22, which may have a form factor between ½ DIN and 10 DIN, at least one display assembly 24, wherein the at least one display assembly 24 is comprised of a display device 26, control electronics and a connector 28, wherein the at least one display device 26 is at least 4 inches. The at least one display assembly 24 may be selected from the group consisting of touch screen, LED display, LCD screen, OLE display, OEM automobile screen, aftermarket automobile screen, plasma display.

The in-vehicle computer system 20 may further comprise a microprocessor system 30, which is comprised of control circuitry, internal memory 32 and data storage device 34. The microprocessor system 30 is contained within the computer system housing 22 and in electrical communication with the display assembly 24 and a power source 36. The data storage device 34 may further comprise a removable storage medium. Running on the microprocessor system 30 is an operating system capable of running multiple applications simultaneously. The operating system may be embedded or open platform, and may be a multithreading operating system.

The in-vehicle computer operating system 80 20 may be programmed to synchronize data with online accounts, as well as synchronize data with personal digital organizers, which are in electrical communication with the computer operating via the in-vehicle peripheral device hardware interface. The in-vehicle computer operating system 80 may function as a contact and appointment manager and may be programmed to organize contact data into at least one group. The in-vehicle computer operating system 80 may be programmed to link address book contact data to appropriate calendar appointments. The in-vehicle computer operating system 80 may also be programmed to send and receive email and facilitate Internet messaging. Via the connection module 70, the in-vehicle computer operating system 80 may also synchronize some or all designated data file with a base station computer 72, even when the vehicle is in a powered off state.

The in-vehicle computer operating system 80. may further comprise a control interface, which maybe the display device 26, also adapted to the small screen environment of an automobile, which makes utilizing the web-browser and Internet browsing capable on small screens. All fonts, menus, buttons and controls are displayed oversized on the in-vehicle computer system display. The in-vehicle computer operating system 80 includes a customized on screen keyboard for data entry. The control interface may also be a remote control interface. Accessibility features of the in-vehicle computer system 20 include speech recognition technology for navigating between menu options, entering data into the system and navigation. Accessibility features also include smart selection function. The in-vehicle computer operating system 80 further comprises speech to text technology to provide minimal driving distraction to the user while using the in-vehicle computer system. The in-vehicle computer operating system 80 may be programmed to automatically download system updates, news data, via a wireless network connection.

The in-vehicle computer operating system 80 may be programmed to operate as a navigation aid as well as play video games, operate as a full feature DVD player, operate as a satellite radio tuner, operate as a media player. The media player may play all commonly accepted audio, video and multimedia file formats, and create and manage play lists. The in-vehicle computer operating system 80 may be programmed to operate as a scientific calculator, or as an alarm clock.

The in-vehicle computer operating system 80 may be programmed to automatically lock the doors of the vehicle when the vehicle's speed sensor input exceeds a preset level as determined through the in-vehicle peripheral device hardware interface 50. The system may be programmed to send a signal through the in-vehicle peripheral device hardware interface 50 to switch on the vehicle's headlights and parking lights when the in-vehicle peripheral device hardware interface receives an input signal indicating darkness. The in-vehicle computer operating system 80 may be programmed to operate as an audio switching source for various regions of the vehicle, and may also operate as a video switching source for various regions of the vehicle.

The in-vehicle computer operating system 80 may be programmed to display nearby locations of interest and appropriate routes of travel on the in-vehicle display assembly. An emergency and first aid feature of the in-vehicle computer system operating system may show nearby hospitals and incorporates navigational functionality for routing, and can also relay information via wireless connectivity in times of distress. The in-vehicle computer system 20 may also send and receive entertainment information including local movie times, show times, as well as dining information via wireless connectivity.

A peripheral device interface 50 is in electrical communication with at least one peripheral device 52 via a peripheral device connector 54 and the microprocessor system 30 via a peripheral device interface connector. The peripheral device connector 54 is selected from the group consisting of from the group consisting of: PCMCIA, USB, Fire Wire, optical digital, RCA, stereo audio, mono audio, RS232, parallel cable, PS/2, VGA, SVGA, XGA, composite video, s-video, coaxial, RJ-45, IDE, SCSI, PCI, IR, and RF. The peripheral device interface 50 may have user mappable inputs and outputs, and may be comprised of at least one micro-controller 58. The peripheral device interface 50 may also have a power management module 60, a voltage detection and display module 62.

The at least one peripheral device 52 may be entertainment peripherals such as digital satellite television receiver, television tuner, radio tuner, compact disc player, compact disc changer, digital video disc player, digital video disc changer and gaming system. The peripheral device interface 54 may also be in communication with peripheral devices 54 such as audio/video source controllers, infrared controller, radio controller, or antennas such as global positioning system antenna, NMAE compatible antenna, and satellite radio antenna. The peripheral device interface may also be in communication with other peripheral devices 52 such as global positioning system device, navigation system, gyroscopic device, communication module, cellular telephone, ODBII vehicle diagnostic computer, and in-vehicle networking. Via the OBDII vehicle diagnostic computer, the in-vehicle computer system 20 can obtain and display automobile diagnostic information such as vehicle speed, tachometer readings, engine temperature and other sensory information from the vehicle on-board computer. Using this information, the in-vehicle computer system 20 may extrapolate other information such as when a tire rotation is needed, oil change, tune-up and other maintenance warnings. The in-vehicle computer system 20 may echo warnings from the vehicle on-board computer to the user, and can also send notification to the user via the wireless connectivity such as email. The in-vehicle computer system 20 may also incorporate “dead-reckoning” technology to extrapolate data from the OBDII connection, gyroscope data and vehicle navigation system data to determine the position of the automobile when GPS satellite signal is unavailable. The peripheral device interface connector 56 may be selected from the group consisting of PCMCIA, USB, Fire Wire, optical digital, RCA, stereo audio, mono audio, RS232, parallel cable, PS/2, VGA, SVGA, XGA, composite video, s-video, coaxial, RJ-45, IDE, SCSI and PCI.

The in-vehicle computer system 20 also further comprises a computer input device 64, and a power supply 66 in electrical communication with the in-vehicle display assembly 26, the microprocessor system 30, and the computer input device 68 and the peripheral device interface 50. The in-vehicle power supply 66 may be a custom 12 Volt power supply suited to the rugged automobile environment, with power filtering functionality to filter fluctuating electrical signals. The power supply 66 may be suited for atx, and mini-itx computer motherboards and may have the ability to soft boot the in-vehicle computer system 20 based on the ignition switch on/off state changes. The power supply 66 may also have the ability to keep the system powered on for an extended period of time after the automobile it shut off. The computer input device 68 is selected from the group consisting of touch screen, gyroscopic mouse, touch pad, joystick, mouse, mousing devices, voice recognition, RF controller, IR controller, USB and IEEE 1394 device.

The in-vehicle computer system 20 may further comprise a communication module 70, wherein the communication module 70 may be in wireless communication with a base station 72 via a communication-module/base-station communication protocol 74. The in-vehicle computer system 20 may also provide wireless Internet connectivity for web browsing, e-mail access, file transfer and streamed data. The base station 72 may be either a home based or office based personal computer, or may be any type of off site computer system such as an Internet service provider. The communication-module/base-station communication protocol 74 may be selected from the group consisting of WiFi, 802.11(a), 802.11(b), 802.11(g), CDMA and GSM. The in-vehicle computer system 20 may be in communication with in vehicle networking 76 via an in-vehicle networking protocol 78 selected from the group consisting CAN, MOST, J1850, VPW, PWM, ISO9141, Byteflyte and LIN.

According to yet another embodiment, a method of synchronizing an in-vehicle computer with a base station computer system is disclosed. The method comprising the following steps: Step 100 determining if network reception is suitable to provide communication with an in-vehicle computer system and a base station computer system. Step 102 establishing a bi-directional network connection between the in-vehicle computer system and the base station computer system. Step 104 is comparing designated data files stored on both the base station computer system and the in-vehicle computer system. Step 106, transmitting and storing updated data files from the base station computer system on the in-vehicle computer system. Step 107 is transmitting and storing updated data files from the in-vehicle computer system on the base station computer system. The data files may be selected from the group consisting of address book file, scheduler file, audio file, video file, entertainment file, text file, adobe acrobat file and excel file. The communication-module/base-station communication protocol is selected from the group consisting of WiFi, 802.11(a), 802.11(b), 802.11(g), CDMA and GSM.

1. An in-vehicle computer system comprising:
a computing system housing;
at least one display assembly, wherein said at least one display assembly is comprised of a display device, control electronics and a connector, wherein said at least one display is at least 4 inches;
a microprocessor system comprised of control circuitry, internal memory and data storage device, wherein said microprocessor system is contained within said computer system housing and in electrical communication with said display assembly, and a power source;
an operating system running on said microprocessor system and capable of running multiple applications simultaneously;
a computer input device;
a peripheral device interface in electrical communication with at least one peripheral device via a peripheral device interface connector and said microprocessor system via a device interface connector; and
a power supply in electrical communication with said in-vehicle display assembly, said microprocessor system, said computer input device and said peripheral device interface.

2. An in-vehicle computer system as in claim 1, wherein said peripheral device interface connector is selected from the group consisting of PCMCIA, USB, FireWire, optical digital, RCA, stereo audio, mono audio, RS232, parallel cable, PS/2, VGA, SVGA, XGA, composite video, s-video, coaxial, RJ-45, IDE, SCSI and PCI.

3. An in-vehicle computer system as in claim 0, wherein said at least one display assembly is selected from the group consisting of touch screen, LED display, LCD screen, OLE display, OEM automobile screen, aftermarket automobile screen, plasma display.

4. An in-vehicle computer system as in claim 0, wherein said computer input device is selected from the group consisting of touch screen, gyroscopic mouse, touch pad, joystick, mouse, mousing devices, voice recognition, RF controller, IR controller, USB and IEEE 1394 device.

5. An in-vehicle computer system as in claim 1, wherein said at least one peripheral device is selected from the group consisting of global positioning system antenna, NMAE compatible antenna, satellite radio antenna, global positioning system device, navigation system, digital satellite television receiver, audio/video source controllers, television tuner, radio tuner, compact disc player, compact disc changer, digital video disc player, digital video disc changer, Infrared controller, radio controller, communication module, cellular telephone, gaming system, ODBII vehicle diagnostic computer, and in-vehicle networking.

6. An in-vehicle computer system as in claim 1, wherein said peripheral device connector is selected from the group consisting of from the group consisting of: PCMCIA, USB, FireWire, optical digital, RCA, stereo audio, mono audio, RS232, parallel cable, PS/2, VGA, SVGA, XGA, composite video, s-video, coaxial, RJ-45, IDE, SCSI, PCI, IR, and RF.

7. An in-vehicle computer system as in claim 1, wherein said housing has a form factor between ½ DIN and 10 DIN.

8. An in-vehicle computer system as in claim 0, wherein said operating system is selected from the group consisting of open platform, and embedded.

9. An in-vehicle computer system as in claim 0, wherein said computer system is further comprised of an operating system executing multiple threads.

10. An in-vehicle computer system as in claim 0, wherein said data storage device is further comprised of a removable storage device.

11. An in-vehicle computer system as in claim 5, further comprising a base station, wherein said communication module is in communication with said base station via a communication-module/base-station communication protocol.

12. An in-vehicle computer system as in claim 11, wherein said communication-module/base-station communication protocol is selected from the group consisting of WiFi, 802.11(a), 802.11(b), 802.11(g), CDMA and GSM.

13. An in-vehicle computer system as in claim 11, wherein said base station is selected from the group consisting of home based personal computer, office based personal computer and Internet Service Provider.

14. An in-vehicle computer system as in claim 1, wherein said peripheral device interface is in communication with in-vehicle networking using an in-vehicle networking communication protocol.

15. An in-vehicle computer system as in claim 14, wherein said in-vehicle networking communication protocol is selected from the group consisting of: CAN, MOST, J1850, VPW, PWM, ISO9141, Byteflyte and LIN.

16. An in-vehicle computer system as in claim 0, wherein said peripheral device interface is further comprised of at least one micro-controller in communication with said at least one peripheral device.

17. An in-vehicle computer system as in claim 16, wherein said at least one peripheral device is selected from the group consisting of global positioning system antenna, NMAE compatible antenna, satellite radio antenna, global positioning system device, navigation system, digital satellite television receiver, audio/video source controllers, television tuner, radio tuner, compact disc player, compact disc changer, digita video disk player, infrared controller, radio controller, communication module, cellular telephone, gaming system, ODBII vehicle diagnostic computer, and in-vehicle networking.

18. An in-vehicle computer system as in claim 0, wherein said peripheral device interface is further comprised of a power management module.

19. An in-vehicle computer system as in claim 0, wherein said peripheral device interface is further comprised of user mappable inputs and outputs.

20. An in-vehicle computer system as in claim 1, wherein said peripheral device interface is in communication with at least two peripheral device via a peripheral device interface connector and said microprocessor system via a device interface connector, wherein at least one of said at least two peripheral devices is an ODBII vehicle diagnostic system.

21. An in-vehicle computer system as in claim 1, wherein said operating system is an embedded multithreading operating system running on said microprocessor system capable of running multiple applications simultaneously.

22. An in-vehicle computer system as in claim 1, wherein said peripheral device interface is in electrical communication with at least two peripheral devices via a peripheral device interface connector, and said microprocessor system via a device interface connector, wherein at least one of said at least two peripheral devices is an ODBII vehicle diagnostic system.

23. A method of synchronizing an in-vehicle computer with a base station computer system comprising the steps of:
determining if network reception is suitable to provide communication with an in-vehicle computer system and a base station computer system;
establishing a bi-directional network connection between said in-vehicle computer system and said base station computer system;
comparing designated data files stored on both said base station computer system and said in-vehicle computer system;
transmitting and storing updated data files from said base station computer system on said in-vehicle computer system; and
transmitting and storing updated data files from said in-vehicle computer system on said base station computer system.

24. A method of synchronizing an in-vehicle computer with a base station computer system as in claim 23, wherein said data files are selected from the group consisting of address book file, scheduler file, audio file, video file, entertainment file, text file, adobe acrobat file and excel file.

25. A method of synchronizing an in-vehicle computer with a base station computer system as in claim 23, wherein said base station computer system is selected from the group consisting of home based personal computer, office based personal computer and Internet Service Provider.

26. A method of synchronizing an in-vehicle computer with a base station computer system as in claim 23, wherein said communication-module/base-station communication protocol is selected from the group consisting of WiFi, 802.11(a), 802.11(b), 802.11(g), CDMA and GSM.
